(19) United States
(12) Patent Application Publication
(10) Pub. No.: US 2025/0005885 A1
(43) Pub. Date: Jan. 2, 2025

(54) OBSTACLE AVOIDANCE PLAYING METHOD AND APPARATUS

(71) Applicant: SAMSUNG ELECTRONICS CO., LTD., Suwon-si (KR)

(72) Inventors: Xianbing TENG, Jiangsu (CN); Jiang YU, Jiangsu (CN); Jianhua BI, Jiangsu (CN); Youxin CHEN, Jiangsu (CN); Soonmook JEONG, Suwon-si (KR); Longhai WU, Jiangsu (CN); Jie CHEN, Jiangsu (CN)

(73) Assignee: SAMSUNG ELECTRONICS CO., LTD., Suwon-si (KR)

(21) Appl. No.: 18/665,133

(22) Filed: May 15, 2024

Related U.S. Application Data
(63) Continuation of application No. PCT/IB2024/053456, filed on Apr. 9, 2024.

(30) Foreign Application Priority Data
Jun. 30, 2023 (CN) 202310789999.1

(51) Int. Cl. G06V 10/26; G06F 3/01; G06V 10/25

(52) U.S. Cl. CPC G06V 10/26; G06F 3/013; G06V 10/25

(57) ABSTRACT

An obstacle avoidance playing method includes acquiring human eye position information of a viewer in a playing scene and three-dimensional data of an object in a respective viewing space region; determining a visible region of a display screen based on the human eye position information, the three-dimensional data of the object, and size and position information of the display screen, the visible region corresponding to a portion of the display screen that is unobstructed to the viewer; and displaying image content using (i) a matched obstacle avoidance mode determined based on the visible region and (ii) a preset obstacle avoidance strategy such that the image content is displayed in the visible region.

### CROSS-REFERENCE TO RELATED APPLICATIONS

This application is a bypass continuation of International Application No. PCT/IB2024/053456, filed on Apr. 9, 2024, which is based on and claims priority to China Patent Application No. 202310789999.1, filed on Jun. 30, 2023, in the China National Intellectual Property Administration, the disclosures of which are incorporated by reference herein in their entireties.

### BACKGROUND

### 1. Field

The present embodiments relate to multimedia playing technology, and particularly, to an obstacle avoidance playing method and apparatus.

### 2. Description of Related Art

At present, with the development of large screen technology, in order to improve image perception, more and more multimedia playing scenes adopt large screen display devices. For example, images displayed by a laser television, a projector, and so on may have a size of 100 inches or more. Such a large playing image enables a user to experience a cinematic viewing experience at home. At the same time, since a very large display image may also present detailed content in the image more comprehensively, in a scene (such as a conference room or teaching environment) that needs to fully display playing contents, a large screen is also often used for presenting the content.

Although a large screen may enhance a user's viewing effect by expanding the playing image, it is also susceptible to obstacles as a viewer's visual space expands, ultimately resulting in the inability to view the complete image content. When the viewer is within a visual range of a display screen, a presence of furniture objects or other individuals may result in obstruction of the viewer's line of sight during the viewing process. Furthermore, even if the viewer changes his or her viewing position, the problem that the image content is blocked cannot be solved, making it difficult for the viewer to view the complete image content.

### SUMMARY

Provided is an obstacle avoidance playing method and apparatus, which may enhance a viewing effect when there is an obstacle in a viewer's visual range.

According to an aspect of the disclosure, an obstacle avoidance playing method, comprising: acquiring human eye position information of a viewer in a playing scene and three-dimensional data of an object in a respective viewing space region; determining a visible region of a display screen based on the human eye position information, the three-dimensional data of the object, and size and position information of the display screen, the visible region corresponding to a portion of the display screen that is unobstructed to the viewer; and displaying image content using (i) a matched obstacle avoidance mode determined based on the visible region and (ii) a preset obstacle avoidance strategy such that the image content is displayed in the visible region.

According to an aspect of the disclosure, an obstacle avoidance playing apparatus, comprises: data collection circuitry, configured to acquire human eye position information of a viewer in a playing scene and three-dimensional data of an object in a respective viewing space region; visible region generation circuitry, configured to determine a visible region of a display screen, based on the human eye position information, the three-dimensional data of the object, and size and position information of the display screen, the visible region corresponding to a portion of the display screen that is unobstructed to the viewer; and obstacle avoidance processing circuitry, configured to display image content using (i) a matched obstacle avoidance mode being determined based on the visible region and (ii) a preset obstacle avoidance strategy such that the image content is displayed in the visible region.

According to an aspect of the disclosure, a non-transitory computer-readable storage medium having instructions stored therein, which when executed by a processor cause the processor to execute an obstacle avoidance playing method comprising: acquiring human eye position information of a viewer in a playing scene and three-dimensional data of an object in a respective viewing space region; determining a visible region of a display screen based on the human eye position information, the three-dimensional data of the object, and size and position information of the display screen, the visible region corresponding to a portion of the display screen that is unobstructed to the viewer; and displaying image content using (i) a matched obstacle avoidance mode determined based on the visible region and (ii) a preset obstacle avoidance strategy such that the image content is displayed in the visible region.

According to one or more embodiments, based on the human eye position information of the viewer in the playing scene and the three-dimensional data of the object in the respective viewing space region acquired in real time and the size and position information of the display screen, the region (i.e., the real visible region) which may be completely viewed by the viewer in the display screen is identified, and then based on the matched obstacle avoidance mode adopted by the region, the image content needing to be played currently is displayed to make the viewer view the complete image content. In this way, the problem that the viewer cannot view the complete playing image due to the obstacle between the human eye and the playing screen may be effectively avoided, thereby getting rid of an influence of the obstacle, and enhancing the viewing effect when there is an obstacle in a visual range of the viewer.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram of a method flow according to one or more embodiments;

FIG. 2 is an example diagram of generating a three-dimensional map according to one or more embodiments;

FIG. 3 is an example diagram of an obstacle calculation according to one or more embodiments;

FIG. 4 is an occlusion example diagram when image content is a single picture according to one or more embodiments;

FIG. 5 is an example diagram of a layout adjustment based on the occlusion in FIG. 4 according to one or more embodiments;

FIG. 6 is an occlusion example diagram when image content contains multiple pictures according to one or more embodiments;

FIG. 7 is an example diagram of a layout adjustment based on the occlusion in FIG. 6 according to one or more embodiments;

FIG. 8 is an occlusion example diagram when image content is a plain text according to one or more embodiments;

FIG. 9 is an example diagram of a layout adjustment based on the occlusion in FIG. 8 according to one or more embodiments;

FIG. 10 is an occlusion example diagram when image content is a special type according to one or more embodiments;

FIG. 11 is an example diagram of a layout adjustment based on the occlusion in FIG. 10 according to one or more embodiments;

FIG. 12 is an occlusion example diagram when image content is a combination of a text and a picture according to one or more embodiments;

FIG. 13 is an example diagram of a layout adjustment based on the occlusion in FIG. 12 according to one or more embodiments;

FIG. 14 is another occlusion example diagram when image content is a combination of a text and a picture according to one or more embodiments;

FIG. 15 is an example diagram of a layout adjustment based on the occlusion in FIG. 14 according to one or more embodiments;

FIG. 16 is an example diagram of blackening an occlusion region according to one or more embodiments;

FIGS. 17 to 19 are schematic diagrams of several application scenes according to embodiments; and

FIG. 20 is a schematic structural diagram of an apparatus according to one or more embodiments.

FIG. 21 is a block diagram for explaining components of an obstacle avoidance playing electronic device, according to one or more embodiments.

### DETAILED DESCRIPTION

Embodiments of the disclosure will be described in detail in conjunction with the accompanying drawings and specific embodiments.

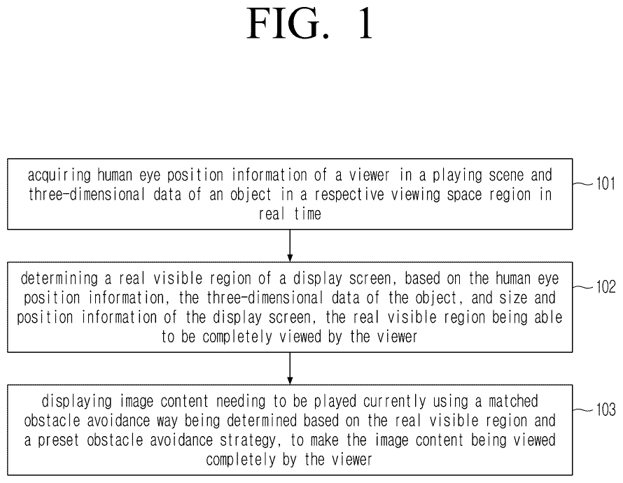

FIG. 1 is a schematic diagram of a method flow according to one or more embodiments of the present embodiments. As shown in FIG. 1, the obstacle avoidance playing method implemented in the embodiment mainly includes the following operations.

At operation 101, human eye position information of a viewer in a playing scene and three-dimensional data of an object in a respective viewing space region are acquired in real time.

In this operation, the human eye position information of the viewer and the three-dimensional data of the object in the respective viewing space region may be acquired to identify a screen region which may be completely viewed by the viewer in subsequent operations, and obstacle avoidance processing is performed based on this screen region to realize an avoidance display of an obstacle between the human eye and a screen so that the viewer may view complete image content or a substantial portion of the image content without being affected by the obstacle in front of the screen.

In one or more examples, the above-mentioned data of the object and human eye position information may be acquired in real time or approximately in real time so that dynamic obstacle avoidance may be achieved in a timely manner. Specifically, the obstacle avoidance processing may be performed in real time with a movement of the obstacle and with a movement of the eye position of the viewer.

In one or more examples, an environment image may be acquired by deploying a sensor in the scene, and a 3D human body detection and a 3D object detection may be performed based on the environment image. The human eye position information of the viewer and the three-dimensional data of the object may be acquired and tracked in real time.

The sensor may be any suitable sensor known to one of ordinary skill in the art, such as a camera, an infrared ray, and a millimeter wave.

The sensor may be deployed on a playing device or other devices but is not limited thereto, as long as the sensor ensures that a complete image of the user's viewing space region is captured.

In one or more examples, the three-dimensional data of the object may include shape and position data to facilitate recognition of a real visible region of a display screen in subsequent operations.

The position and shape data of the object may be 3D point cloud data to facilitate calculation and ensure the accuracy of a calculation result.

The above-mentioned detection and tracking may be implemented adopting, for example, but not limited to, spatial modeling using a simultaneous localization and mapping (slam) method, human body detection, ranging, and localization using the millimeter wave, or any other suitable method known to one of ordinary skill in the art.

At operation 102, a real visible region of a display screen is determined based on the human eye position information, the three-dimensional data of the object, and size and position information of the display screen, the real visible region being able to be completely viewed by the viewer.

This operation is used for determining the real visible region which may be completely viewed by the viewer on the display screen in real time based on the information data acquired in operation 101 to perform the obstacle avoidance processing based on this region in subsequent operations, thereby ensuring that the viewer can view the complete playing image content without being affected by the obstacle between the viewer and the screen.

In one or more examples, in order to improve the accuracy of the determined real visible region, for example, the real visible region of the display screen may be determined by adopting the following methods.

In one or more examples, a three-dimensional map of the playing scene is established based on the human eye position information, the three-dimensional data, and the size and position information of the display screen.

In this operation, a stereoscopic 3D map is established based on the human eye position and the size and position of the 3D object obtained in operation 101 in combination with the size and position of the display screen, and the position and size of each object will be accurately marked on the 3D map.

In one or more examples, the 3D map may be established with the playing device as an origin of coordinates to facilitate the calculation.

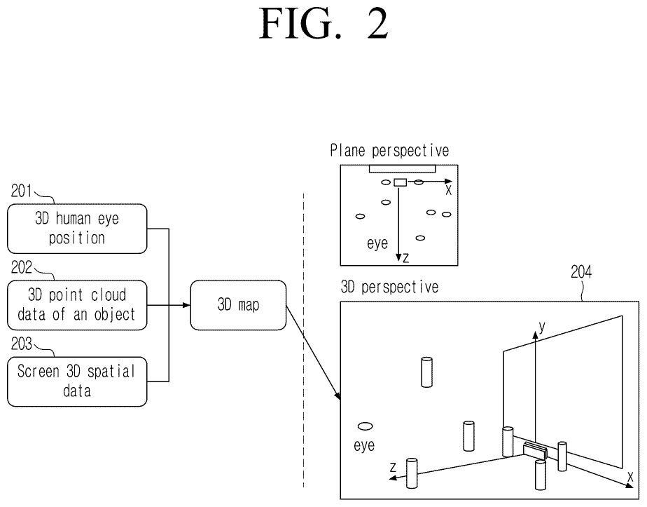

FIG. 2 shows an example diagram of generating a three-dimensional map according to one or more embodiments. As shown in the figure, in the example, the playing device is taken as the origin of coordinates, a size and a position of a playing image are acquired from the playing device, and then a 3D human eye position (201) and point cloud data of a 3D object (202) within a range of the spatial region between the human eye and the screen (203) are mapped into a map to obtain a three-dimensional map of a current playing scene (204).

In the operation 102, for each viewer, a corresponding occlusion region in the display screen of each obstacle within a viewing range of the viewer is determined based on the three-dimensional map.

This operation is used for determining for each viewer a screen display region which cannot be viewed under an influence of the obstacle so that a real visible region which may be completely viewed by the viewer may be ensured based on this determination in subsequent operations.

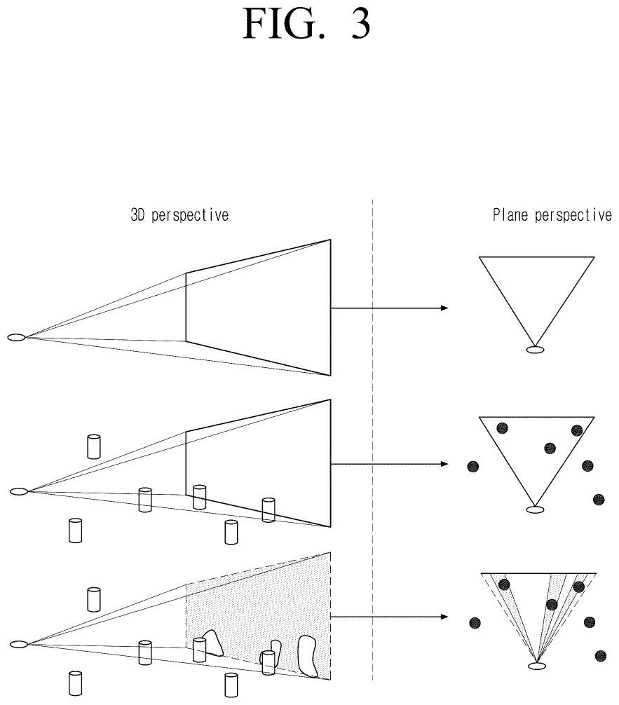

FIG. 3 shows an example diagram of an obstacle calculation. In one or more examples, as shown in FIG. 3, specifically, the following operations a1-a2 may be adopted in operation 102. For each viewer, the corresponding occlusion region in the display screen of each obstacle within the viewing range of the viewer is determined.

At operation a1, a visible cone range of the viewer is obtained based on a human eye position of the viewer in the three-dimensional map and the size and position information of the display screen.

This operation is used for generating a visible cone between the human eye of the viewer and the display screen, such as a cone shown in FIG. 3.

In the 3D map the visible cone may be obtained by connecting the eye with corner points of a playing plane.

At operation a2, for each of the objects, whether the object has a point in the visible cone range is determined based on reconstruction data of the object in the three-dimensional map, and if so, a display region which is not able to be viewed by the viewer due to occlusion of the object is calculated, as the occlusion region corresponding to the object.

In one or more examples, the reconstruction data of the object in the three-dimensional map is data obtained by mapping the three-dimensional data of the object to the three-dimensional map.

In this operation, if the object does not have a point existing in the visible cone range, it may be determined that the object will not occlude a viewing field of a respective viewer (e.g., for the respective viewer), and the object is not an obstacle. Therefore, in this scenario, there is no occlusion region. If the object has a point existing in the cone range, it may be determined that the object is an obstacle for the respective viewer, and a viewing image of the respective viewer is occluded. Specifically, when the three-dimensional data of the object is the point cloud data, if the point clouds of the object are all in the cone, then the object is an integral obstacle. If it is determined that some of the point clouds of the object are in the cone, the points in the cone and a respective conical surface region are combined into obstacles. For the obstacle, a perspective transformation method may be used to calculate a respective display region occluded by the object (e.g., the occlusion region), and a specific calculation method is mastered by a person skilled in the art.

At operation 102, the real visible region of the display screen is generated based on each occlusion region.

In one or more examples, in order to facilitate subsequent obstacle avoidance processing, in this operation 102, the real visible region is obtained by removing each occlusion region from a complete display region of the display screen. Thus, all viewers can completely view the obtained real visible region, and accordingly, performing subsequent obstacle avoidance processing only based on the real visible region can ensure that all viewers can view the complete playing image content.

At operation 103, image content needing to be currently played is displayed using a matched obstacle avoidance mode being determined, based on the real visible region, and a preset obstacle avoidance strategy, to make the image content being viewed completely by the viewer.

In one or more examples, the obstacle avoidance strategy is used for configuring the matched obstacle avoidance mode for different application scenarios, and specifically, an appropriate strategy may be set in advance according to practical application needs.

In one or more examples, an existing obstacle avoidance mode may be adopted to display the image content completely in the real visible region. For example, in a scene where a projector is used for playing, a projection region of the projector may be reduced and/or moved so that the image content may be completely displayed in the real visible region.

In one or more examples, in order to enhance the flexibility of the obstacle avoidance processing and expand applicable scenes, one or more embodiments also consider performing the obstacle avoidance processing by adopting an obstacle avoidance mode for adjusting a content layout. For example, a layout of the image content is adjusted based on the real visible region so that the image content is completely displayed in the real visible region.

In one or more examples, considering that the viewer may have a standby display device in a practical playing scene, and in this case, when a viewing image of this viewer is occluded, it is considered to use its standby display device for image playing. Accordingly, in one or more examples, the obstacle avoidance strategy may be specifically set to include the following content:
when the real visible region is smaller than the size of the display screen, a split-screen display mode is adopted to display the image content completely in a screen of the standby display device, or the obstacle avoidance mode for adjusting a content layout is adopted to display the image content completely in the real visible region.

Further, in one or more examples, in the above-mentioned obstacle avoidance strategy, which mode is adopted for the obstacle avoidance processing may also be set in the obstacle avoidance strategy according to actual needs (e.g., whether the split-screen display mode or the obstacle avoidance mode for adjusting a content layout is adopted). For example, in one or more examples, the obstacle avoidance strategy may be specifically set to include the following content:
when the real visible region is smaller than the size of the display screen, if there is a respective standby display device for the viewer, the split-screen display obstacle avoidance mode is adopted to display the image content completely in the screen of the standby display device;
when the real visible region is not smaller than the size of the display screen, the obstacle avoidance mode for adjusting a content layout is adopted to display the image content completely in the real visible region.

In the above-mentioned obstacle avoidance strategy, when the viewer has the standby display device, the split-screen display obstacle avoidance mode is adopted, and the standby display device is used for image display. In one or more examples, in order to further enhance a user experience, such split-screen display mode needs to be adopted with the consent of the user, and when the viewer disagrees, the obstacle avoidance mode for adjusting a content layout is adopted to overcome an influence of the obstacle. The obstacle avoidance mode for adjusting a content layout will adjust the layout of the image content based on the real visible region, and therefore, the image content may be completely displayed in the real visible region.

The above-mentioned obstacle avoidance strategy is merely an implementation example and is not limited to practical application. For example, the obstacle avoidance strategy may be set by comprehensively using obstacle avoidance modes such as adjusting the content layout, split-screen display, and adjusting the projection region of the projector.

In order to enable one or more embodiments to be better applied to the case where a picture is included in the image content, it is possible to set the obstacle avoidance mode for adjusting a content layout based on smallest indivisible display elements (e.g., referred to herein as primitives) in the image content by taking advantage of a division characteristic of actual image content in advance. For example, in one or more examples, the above-mentioned obstacle avoidance mode for adjusting a content layout may be specifically realized by adopting one or more of the following technical features. In one or more examples, when an image of a single scene (e.g., landscape, sports game, movie scene) is displayed, the primitive may be the entire scene is self. In one or more examples, when one or more images are being displayed, each image may be a separate primitive. In one or more examples, when an image of multiple lines of text or different groupings of text are displayed, each line of text or each grouping of text may be a separate primitive. In one or more examples, when an image of a scene and text are displayed, the scene and the text may be separate primitives.

In one or more examples, all primitives of the image content are completely displayed in the real visible region by adjusting a layout of the primitives in the image content.

In one or more examples, the primitives are the smallest indivisible display elements in the image content, such as one picture, one word, or an indivisible picture part of one picture after removing the text and blank.

In one or more examples, the above-mentioned obstacle avoidance mode for adjusting a content layout may be further realized by adopting the following operations.

At operation b1, a type of the image content is identified, where the type includes a plain text, a plain picture, a combination of a text and a picture, and a special type; the special type is image content containing special primitives; elements of the special primitives having interrelated structural relationships with each other.

Considering different formats of the image content, adopted adjustment modes may be different. For example, for the picture, the layout may be adjusted by scaling, moving, etc.; for the word, the layout may be adjusted by changing typesetting formats, such as word spacing, line spacing, and word size. Therefore, the embodiments of the present disclosure identify the type of the image content before adjusting the content layout of the image.

In one or more examples, the plain text means that the image content is composed of only the content in text format; the pure picture means that the image content is composed of only the content in picture format.

It should be noted that the smallest indivisible display elements in some image content may contain multiple elements. These elements may be bound in some displays due to their interrelated structural relationships to present an interrelated relationship between them. For example, there is a corresponding relationship between notes in a song and words in lyrics. Therefore, when adjusting the layout of the image content, the interrelated structural relationships between these elements may be considered to avoid being destroyed. For this reason, the embodiment introduces a concept of the special primitive, which combines the elements with the interrelated structural relationships and divides them into one special primitive (e.g., one music score primitive containing chords, musical notes, and lyrics) to ensure that the interrelated structural relationships between the elements is not destroyed.

In one or more examples, a pre-trained artificial intelligence model (e.g., CNN/KNN/SVM) may be used to identify the type of the image content based on a picture played, and a specific implementation method is mastered by a person skilled in the art.

At operation b2, display attribute information of each primitive in the image content is acquired according to an identified type, the display attribute information including: size and position coordinate information of the each primitive in the picture and information of spacing with a neighboring primitive and an arrangement direction.

In one or more examples, the pre-trained artificial intelligence model (such as CNN, KNN, and SVM) may be used to extract the primitive based on the picture played, and a specific implementation method is mastered by a person skilled in the art.

In one or more examples, the display attribute information of each primitive in the image content may be acquired by adopting the following methods.

At operation b21, the primitives in the image content is extracted according to the type of the image content to obtain the size and position coordinate information of each primitive in the image content in the picture.

In one or more examples, after the primitives is extracted, size and position information of the primitive in a respective picture may be obtained.

At operation b22, information of spacing with a neighboring primitive and an arrangement direction of a respective primitive in the picture is obtained based on the size and position coordinate information of the each primitive in the picture.

This operation is used for obtaining typesetting information between each primitive and its upper, lower, left, and right neighboring primitives, including spacing and arrangement direction (horizontal, longitudinal), etc.

At operation b3, a primitive which is not able to be completely covered by the real visible region is searched based on the display attribute information of the primitive, as an occluded primitive.

This operation is used for determining which primitives belong to primitives that cannot be completely displayed in the real visible region (e.g., the occluded primitives). Thus, in subsequent operations, these occluded primitives may avoid an occluded display region by adjusting the layout of these primitives to be displayed in the real visible region.

At operation b4, the layout of the primitives in the image content is adjusted based on the type of the image content, the display attribute information of the primitives, and a type of the occluded primitive, according to a preset rearrangement strategy, to display the occluded primitive completely in the real visible region.

In one or more examples, an appropriate rearrangement strategy may be set according to practical application needs. In one or more examples, the rearrangement strategy may specifically set the following rules:
when the type of the image content is the plain picture, a maximum region which may be occupied by the occluded primitive in the real visible region is determined, and after reducing the occluded primitive to be completely displayed in the maximum region based on the display attribute information of the primitives, a position of the occluded primitive is moved to display the occluded primitive completely in the maximum region.

In one or more examples, when the type of the image content is the plain picture, in order to ensure that all primitives can avoid the occlusion of the obstacle after adjusting the layout and be displayed in a display region which can be completely viewed by the viewer, it is necessary to first determine the maximum region which may be occupied by the occluded primitive in the real visible region. Then, the primitive is completely displayed within a range of the region by reducing and moving the primitive.

In one or more examples, a person skilled in the art may adopt a matched strategy to determine the maximum region which may be occupied by the occluded primitive in the real visible region according to practical application needs. For example, in one or more examples, the above-mentioned maximum region may be extracted in a blank display region of the image in the real visible region, and a blank display region which may be occupied by the occluded primitive may also be expanded by moving and reducing other primitives based on display requirements of the occluded primitive so that the occluded primitive may be better displayed in the blank display region.

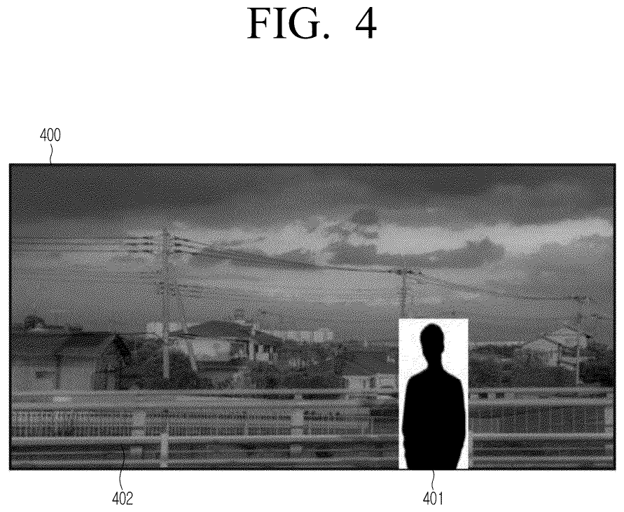

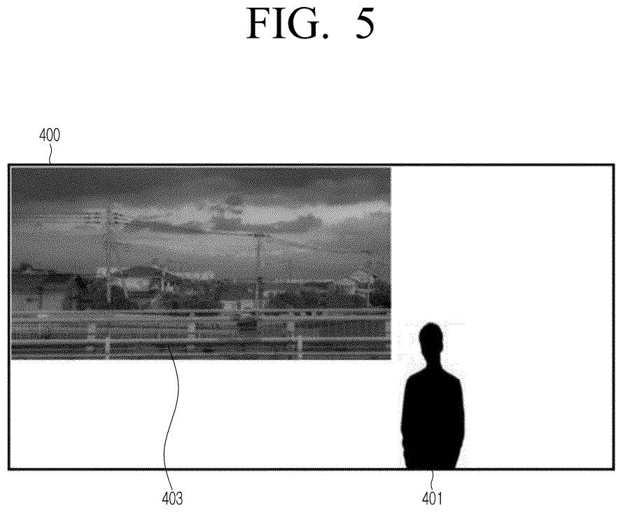

FIG. 4 is an occlusion example diagram when image content is a single picture, and FIG. 5 is an example diagram of a layout adjustment based on the occlusion in FIG. 4. As shown in FIG. 4, there is only a single picture (402) primitive in the image, and since a human shadow (401) appears in an occlusion image of a person, a real visible region is a display region with the human shadow removed. At this time, a screen region where a picture may be completely displayed being a rectangular region at an upper left corner is calculated and learned by determining a strategy based on a preset maximum region, and after correspondingly reducing the picture according to a size of the region, the picture is moved to be completely displayed in the region (403) so that the image content of the picture may avoid the occlusion of a person (401), as illustrated in FIG. 5.

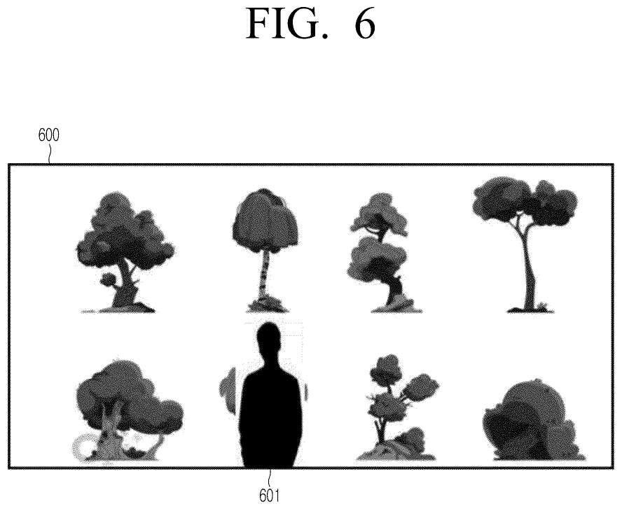

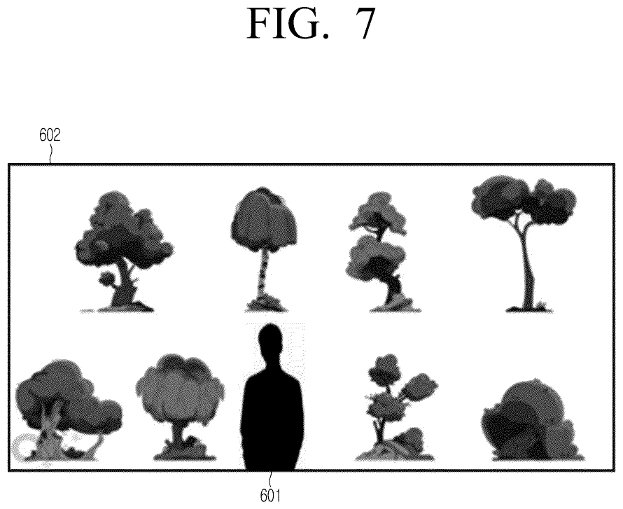

FIG. 6 is an occlusion example diagram when image content contains multiple pictures, and FIG. 7 is an example diagram of a layout adjustment based on the occlusion in FIG. 6.

As shown in FIG. 6, there are multiple picture primitives in the image (600), where one primitive is occluded by a person (601), and accordingly, a real visible region is a display region with the shadow of the person removed. In one or more examples, a primitive on a left side of the picture may be moved to an edge of the picture by determining the strategy based on the preset maximum region to provide a larger blank region for the occluded primitive, and then a maximum region which may be occupied by the occluded primitive in the real visible region being located in a blank region on a left side of the occluded primitive is determined based on a blank display region in the real visible region. Finally, the occluded primitive is moved to be completely displayed in the region so that the image content of the picture may avoid the occlusion of a person (601), thereby being completely displayed in the real visible region (602), as shown in FIG. 7.

2) When the type of the image content is the plain text or the special type, the real visible region is taken as a screen region for displaying the image content, and based on the display attribute information of the primitives, a respective re-typesetting is performed on the primitives in the image content to display the primitives completely in the real visible region.

In one or more examples, the type of the image content is the plain text or the special type, in order to ensure that all primitives can avoid the occlusion of the obstacle after adjusting the layout and be displayed in a display region which can be completely viewed by the viewer, the real visible region needs to be used as a screen region for displaying the whole image content, and the primitives in the image are completely displayed within a range of the real visible region by performing the respective re-typesetting on the these primitives.

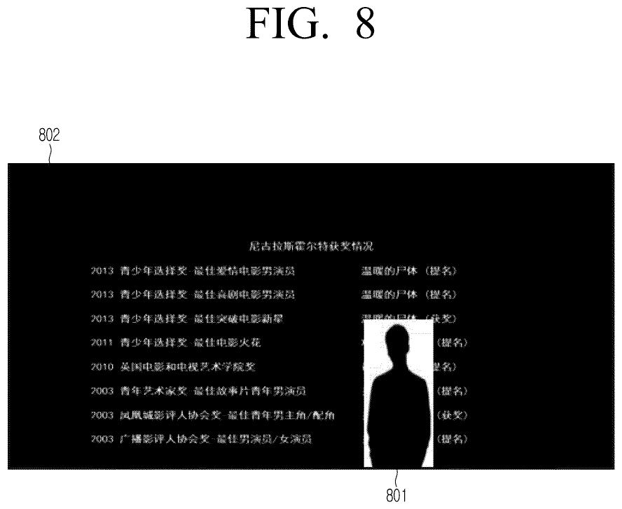

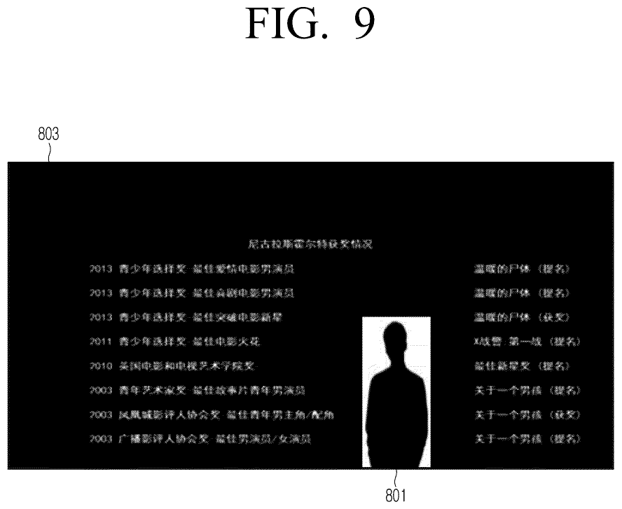

FIG. 8 is an occlusion example diagram when image content is a plain text, and FIG. 9 is an example diagram of a layout adjustment based on the occlusion in FIG. 8.

As shown in FIG. 8, there are multiple word primitives in the image (802), wherein a part of the word primitives is occluded by a person (801), and accordingly, a real visible region is a display region with the shadow of the person removed. At this time, respective re-typesetting may be performed on the primitives in the image within a range of the real visible region so that the primitives are completely displayed within the range of the real visible region (803), as illustrated in FIG. 9.

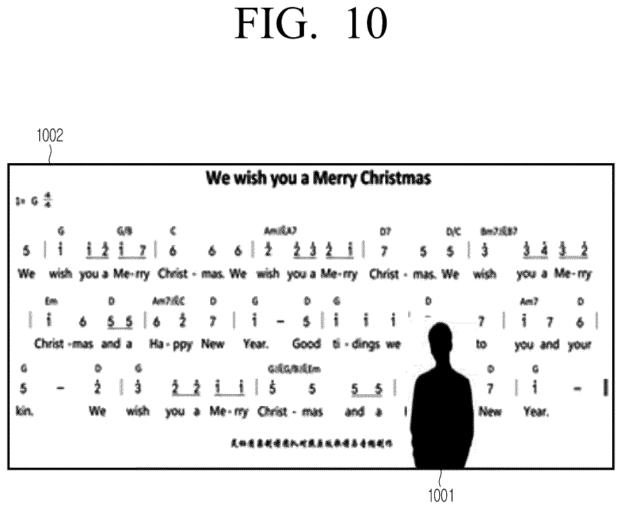

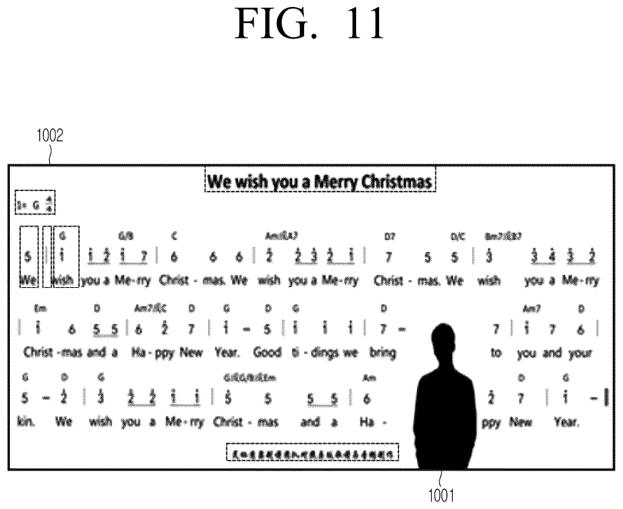

FIG. 10 is an occlusion example diagram when image content is a special type, and FIG. 11 is an example diagram of a layout adjustment based on the occlusion in FIG. 10.

As shown in FIG. 10, the image contains a series of special primitives (e.g., the music score primitives) (1002), where several special primitives are occluded by a person (1001), and accordingly, a real visible region is a display region with the human shadow removed. At this time, respective re-typesetting may be performed on the special primitive in the image within the range of the real visible region so that the special primitive is completely displayed within the range of the real visible region (1002), as illustrated in FIG. 11.

In one or more examples, in order to reduce an operation overhead of the re-typesetting, after the primitives are extracted, the primitives may be grouped according to a preset grouping strategy based on the type of the primitive, the size and position coordinate information in the picture, and the information of spacing with the neighboring primitive and the arrangement direction. When performing respective re-typesetting on the primitives in the image, only primitives of a group in which the occluded primitives are located may be considered for re-typesetting, and if this method fails, all the primitives are considered for re-typesetting to reduce the operation overhead of the re-typesetting.

3) When the type of the image content is the combination of the text and the picture, the following two cases may be distinguished for processing.

Case 1, if the occluded primitive is the picture primitive, a region occupied by the text in the image content is removed from the real visible region to obtain a first sub-region, a maximum region which may be occupied by the occluded primitive in the first sub-region is calculated, and based on the display attribute information of the primitive, after reducing the occluded primitive to be completely displayed in the maximum region, a position of the occluded primitive is moved to display the occluded primitive completely in the maximum region.

In one or more examples, when the image content contains both the text and the picture, if the occluded primitive is only the picture primitive, firstly the region occupied by the text information (containing the special primitive) is removed from the real visible region to obtain a display region (e.g., the first region) which may be occupied by the picture in the image content, and then, layout of the picture in the image content is rearranged based on the first region to calculate the maximum region which may be occupied by the occluded primitive in the first sub-region. Finally, after reducing the occluded primitive to be completely displayed in the maximum region, the occluded primitive is moved accordingly to be completely displayed in the maximum region.

Considering that there may be a certain requirement for a display effect of a picture in some application scenarios, if the first region is too small, it may not be able to ensure that an actual picture meets the display requirement; at this time, in combination with the re-typesetting of the text information, the first region which may be occupied by the picture may be expanded by reducing a display region occupied by the text to ensure the display effect of the picture.

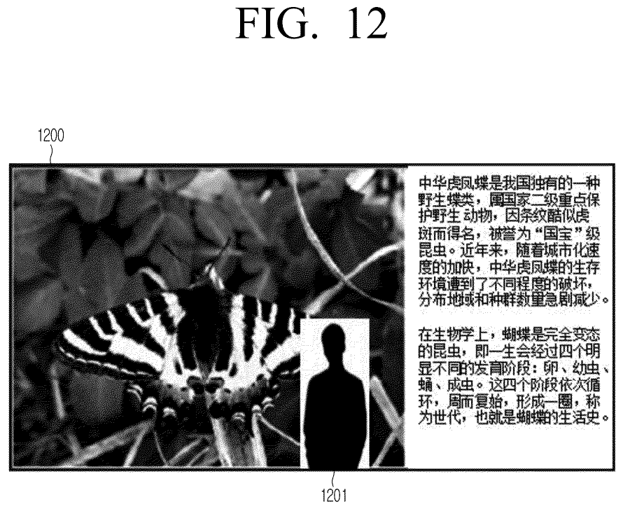

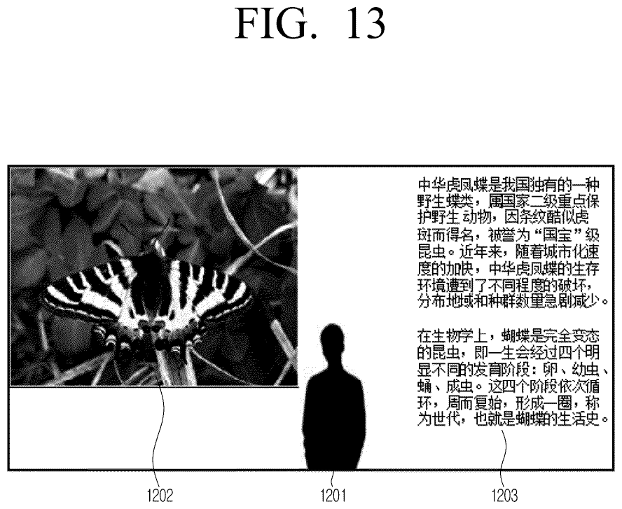

FIG. 12 is an occlusion example diagram when image content is a combination of a text and a picture, and FIG. 13 is an example diagram of a layout adjustment based on the occlusion in FIG. 12.

As shown in FIG. 12, the image contains one picture primitive and a series of text primitives (1200), where the picture primitive is occluded by a person (1201), and accordingly, a real visible region is a display region with the human shadow removed. In one or more examples, the region occupied by the text information (1203) may be removed within the range of the real visible region to obtain the first region which may be occupied by the picture in the image content, and then, a maximum region which may be occupied by an occluded picture primitive in a first sub-region being a rectangular region at an upper left corner is calculated based on the first region. Finally, after reducing the picture primitive to be completely displayed in the rectangular region, the picture primitive is moved accordingly to be completely displayed in the rectangular region (1202), as illustrated in FIG. 13.

Case 2, if the occluded primitive contains the word primitive or the special primitive, a first area which needs to be occupied when text content in the image content is displayed in the real visible region is calculated. Based on the first area, a maximum region which may be occupied when picture content of the image content is displayed in the real visible region is determined, and based on the display attribute information of the picture primitive, after reducing the picture primitive in the image content to be completely displayed in the maximum region, a position of the picture primitive is moved to display the picture primitive completely in the maximum region. In one or more examples, a remaining region in the real visible region after removing the maximum region is taken as a display region of a text primitive in the image content, and based on the display attribute information of the text primitive, a respective re-typesetting is performed on the text primitive in the image content to display each text primitive in the remaining region, an area of the remaining region being not less than the first area.

In one or more examples, when the image content contains both the text and the picture, if the occluded primitive contains the word primitive or the special primitive, the first area which needs to be occupied when the text content in the image content is displayed in the real visible region is calculated. Based on the first area, the maximum region which may be occupied when the picture content of the image content is displayed in the real visible region is determined, and it is ensured that the area of the remaining region in the real visible region after removing the maximum region is not less than the first area so that the text content in the image content may be completely displayed in the remaining region after performing the re-typesetting. Then, the picture primitive may be completely displayed in the above-mentioned maximum region determined for the picture primitive by reducing and moving the picture primitive in the image content, thereby ensuring that the text and the picture in the image content may be completely displayed in the real visible region.

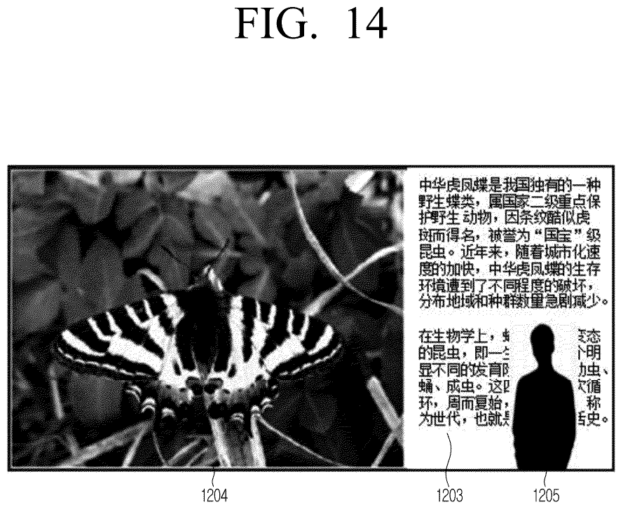

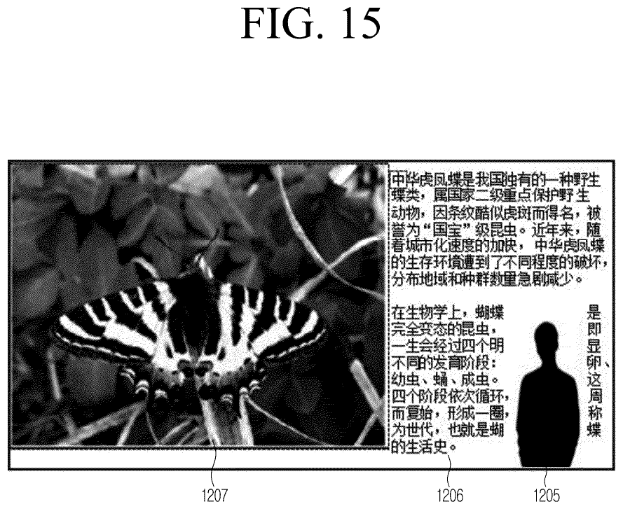

FIG. 14 is another occlusion example diagram when image content is a combination of a text and a picture, and FIG. 15 is an example diagram of a layout adjustment based on the occlusion in FIG. 14.

As shown in FIG. 14, the image contains one picture primitive (1204) and a series of text primitives (1203), where part of the text primitives is occluded by a person (1205), and accordingly, a real visible region is a display region with the human shadow removed. In one or more examples, the maximum region which may be occupied by the picture content of the image content when being displayed in the real visible region may be obtained based on the first area that needs to be occupied by the text content when being displayed in the real visible region, and then the picture primitive is reduced and moved to be completely displayed in the above-mentioned maximum region determined for the picture primitive. In one or more examples, respective re-typesetting is performed on the text primitive in the image content in the remaining area after removing the maximum region to display all the text primitives in the above-mentioned remaining region so that the text (1206) and the picture (1207) in the image content may be completely displayed in the real visible region, illustrated in FIG. 15.

The above-disclosure is only an example of the rearrangement strategy. As understood by one of ordinary skill in the art, any suitable rearrangement strategy may be implemented.

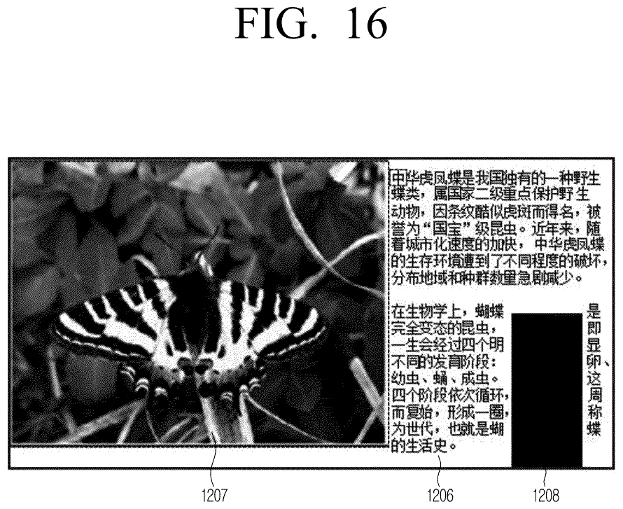

Further, in order to improve the viewing experience of the viewer, an output of a light source may be controlled based on the occluded display region, and after an occlusion region is covered with a black rectangle (1208), a picture after adjusting the content layout is outputted to reduce an influence of light on human eyes, as shown in FIG. 16. In one or more examples, if the projector supports, a light source control module may be added to output no light source for the occluded region part so that the light does not strike a human body occlusion region.

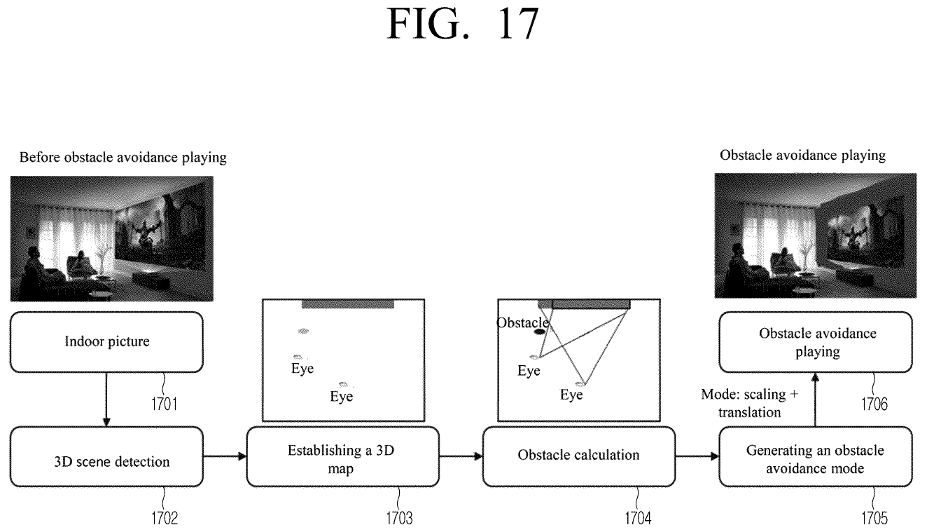

It can be seen from the above-mentioned technical solutions that the method embodiment determines the real visible region which may be completely viewed by the viewer by detecting the obstacle between the human eye and the screen, and actively avoids the obstacle in the user viewing space region. The playing image is displayed based on the real visible region so that the viewer may view the complete image content without being affected by the obstacle between the human eye and the screen, thereby improving the viewing effect when there is an obstacle in the visual range of the viewer. Specific application of the above-described method embodiments is described in detail below in conjunction with several specific application scenes shown in FIGS. 17 to 19.

### Scene 1. Obstacle Avoidance Playing Based on Laser Television/Projector

Many projectors are equipped with cameras. Indoor pictures may be collected through cameras (1701), and capturing may be performed through mobile phones and other devices. As shown in FIG. 17, according to one or more embodiments, an eye position of a viewer and point cloud data of each object are identified (1702), and based on these data, a 3D map is constructed (1703) and a shape and a position of an obstacle between a screen and the eye of the user are calculated (1704). A real visible region may be calculated through the mapping of the obstacle on the screen. Finally, according to the current video content and playing scene, an appropriate obstacle avoidance solution is matched (1705) and played to all viewers (1706).

### Scene 2. Obstacle Avoidance Playing Based on Intelligent Blackboard

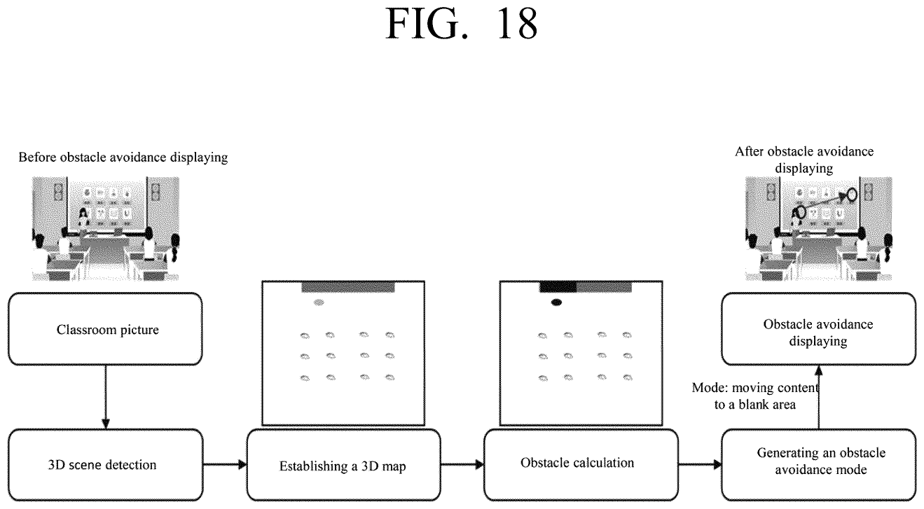

A monitoring camera may be deployed in a classroom. A photograph of a classroom scene is captured by the monitoring camera. As shown in FIG. 18, eye positions of students and point cloud data of a teacher are identified based on the photograph of the classroom scene. A 3D map is constructed and a screen region occluded by the teacher is calculated to generate a real visible region. By adjusting a content layout based on the real visible region, occluded image content is moved to a blank region to be displayed to the students.

### Scene 3. Obstacle Avoidance Display Based on Conference Tablet

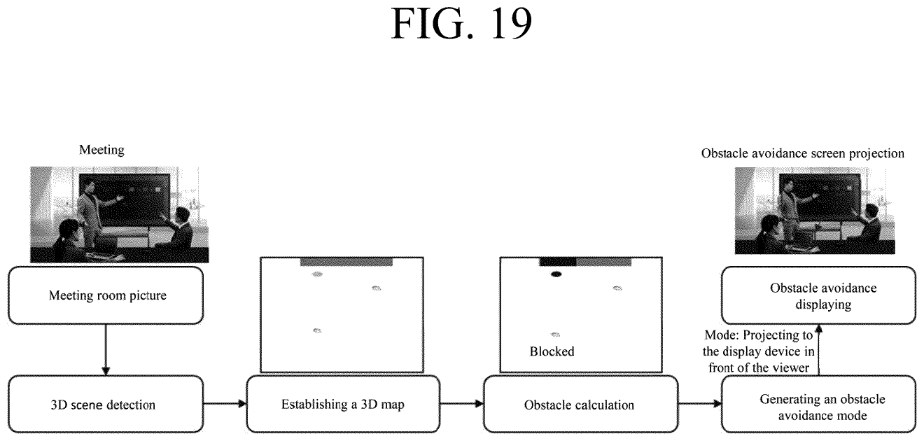

As shown in FIG. 19, a conference room photograph is collected, and eye positions of participants and point cloud data of a speaker are identified based on the conference room photograph. A 3D map is constructed and a screen region occluded by the speaker is calculated to generate a real visible region for the participants. According to the current playing scene, the played image content is projected to a participant who has a standby display device to avoid the occlusion of a display region by the speaker.

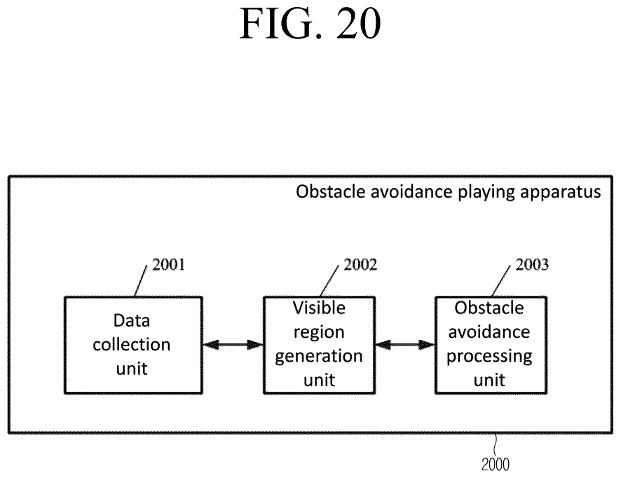

Based on the above-mentioned method embodiments, one or more embodiments accordingly also proposes an obstacle avoidance playing apparatus (2000). As shown in the figure, the apparatus includes:
a data collection unit 2001, configured to acquire human eye position information of a viewer in a playing scene and three-dimensional data of an object in a respective viewing space region in real time;
a visible region generation unit 2002, configured to determine a real visible region of a display screen based on the human eye position information, the three-dimensional data of the object, and size and position information of the display screen, the real visible region being able to be completely viewed by the viewer; and
an obstacle avoidance processing unit 2003, configured to display image content needing to be played currently using a matched obstacle avoidance mode being determined based on the real visible region and a preset obstacle avoidance strategy, to make the image content being viewed completely by the viewer. Each unit illustrated in FIG. 20 may be implemented by individual circuitry, or by a processor.

It should be noted that the above-mentioned method and apparatus are based on a same inventive concept, and since the principles of the method and apparatus for solving the problems are similar, the implementation of the apparatus and method may be referred to each other, and the repetition will not be repeated.

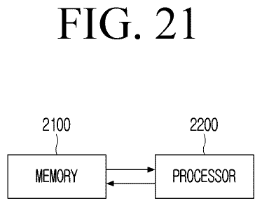

FIG. 21 is a block diagram for explaining components of an obstacle avoidance playing electronic device, according to one or more embodiments.

As shown in FIG. 21, an obstacle avoidance playing electronic device may comprise memory (2100) and processor (2200).

The device may comprise one or more processors, such as the processor (2200). The processor (2200) may be implemented in hardware, firmware, and/or a combination of hardware and software. For example, the processor 2200 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor (2200) also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

Based on the above-mentioned method embodiments, one or more embodiments also proposes an obstacle avoidance playing electronic device, including a processor (2200) and a memory (2100); an application program executable by the processor is stored in the memory and is configured to cause the processor to perform the implementation methods of the obstacle avoidance playing method as described above. Specifically, a system or apparatus may be provided that is equipped with a storage medium on which a software program code that implements functions of any one of the implementations in the above-mentioned embodiments is stored, and causes a computer (or CPU or MPU) of the system or apparatus to read out and execute the program code stored in the storage medium. In addition, some or all of the practical operations may be completed by an operating system or the like operating on the computer through instructions based on the program code. The program code read from the storage medium may also be written into a memory provided in an expansion board inserted into the computer or a memory provided in an expansion unit connected to the computer, and then an instruction based on the program code causes a CPU or the like installed on the expansion board or the expansion unit to perform some or all of the practical operations, thereby realizing the functions of any one of the above-mentioned obstacle avoidance playing method implementations.

The memory (2100) may be specifically implemented as multiple storage media such as an electrically erasable programmable read-only memory (EEPROM), a flash memory, and a programmable program read-only memory (PROM). The processor may be implemented to include one or more central processing units or one or more field programmable gate arrays, where the field programmable gate arrays integrate one or more central processing unit cores. In particular, the central processing unit or central processing unit core may be implemented as CPU or MCU.

One or more embodiments implements a computer program product, including a computer program/instruction; when executed by a processor, the computer program/instruction implements the operations of the obstacle avoidance playing method as described above.

It should be noted that not all the operations and modules in the above-mentioned flowcharts and structure diagrams are necessary, and some operations or modules may be omitted according to practical needs. An order in which each operation is performed is not fixed and may be adjusted as needed. The division of various modules is merely to facilitate the description of the functional division adopted, and in a practical implementation, one module may be implemented by multiple modules, functions of multiple modules may also be implemented by a same module, and these modules may be in a same device or different devices.

Hardware modules in the various implementations may be implemented mechanically or electronically. For example, one hardware module may include a specially designed permanent circuit or logic device (such as a dedicated processor, such as an FPGA or ASIC) for completing a particular operation. The hardware module may also include a programmable logic device or circuit (such as including a general purpose processor or other programmable processors) temporarily configured by software for performing a particular operation. Implementation of the hardware modules mechanically, using a dedicated permanent circuit, or using a temporarily configured circuit (such as configured by software) may be determined based on cost and time considerations.

Herein, “schematic” means “serving as an instance, example, or description”, and any illustration, implementation described herein as “schematic” should not be construed as a more preferred or advantageous technical solution. In order to make the drawings concise, only those parts of the drawings that are related to the present embodiments are schematically depicted and are not representative of a practical structure of the product. In addition, in order to make the drawings concise and easy to understand, only one of the components having a same structure or function in some of the drawings is schematically depicted, or one of them is marked. Herein, “a” does not mean to limit the number of relevant parts of the present embodiments to “only one”, and “a” does not mean to exclude the case that the number of relevant parts of the present embodiments is “more than one”. Herein, “upper”, “lower”, “front”, “back”, “left”, “right”, “inside”, “outside”, and the like are used merely to represent relative positional relationships between relevant parts and do not limit absolute positions of these relevant parts.

The solutions described in the present specification and embodiments, if involving personal information processing, will be processed on the premise of legality (for example, obtaining the consent of the personal information subject or being necessary for the performance of the contract), and will only be processed within the specified or agreed scope. The user refuses to process personal information other than the necessary information required for basic functions without affecting the user's use of basic functions.

In summary, the above are only example embodiments and are not intended to limit the scope of the present embodiments. Any modification, equivalent substitution, improvement, and so on made within the spirit and principle of the present embodiments shall be included in the scope of the present embodiments.

What is claimed is:

1. An obstacle avoidance playing method comprising:
acquiring human eye position information of a viewer in a playing scene and three-dimensional data of an object in a respective viewing space region;
determining a visible region of a display screen based on the human eye position information, the three-dimensional data of the object, and size and position information of the display screen, the visible region corresponding to a portion of the display screen that is unobstructed to the viewer; and
displaying image content using (i) a matched obstacle avoidance mode determined based on the visible region and (ii) a preset obstacle avoidance strategy such that the image content is displayed in the visible region.

2. The method according to claim 1, wherein the determining the visible region of the display screen comprises:
establishing a three-dimensional map of the playing scene based on the human eye position information, the three-dimensional data, and the size and position information of the display screen;
determining, for each viewer, a corresponding occlusion region in the display screen of each obstacle within a viewing range of the viewer based on the three-dimensional map; and
generating the visible region of the display screen based on each occlusion region.

3. The method according to claim 2, wherein the determining the corresponding occlusion region in the display screen of each obstacle within the viewing range of the viewer based on the three-dimensional map comprises:
obtaining a visible cone range of the viewer based on the human eye position of the viewer in the three-dimensional map and the size and position information of the display screen; and
determining, as the occlusion region for each of the objects, whether the object has a point in the visible cone range based on reconstruction data of the object in the three-dimensional map, and based on determining that the object has the point in the visible cone range, calculating a display region which is not viewable by the viewer due to occlusion of the object.

4. The method according to claim 2, wherein the generating the visible region of the display screen comprises:
removing each occlusion region from a complete display region of the display screen to obtain the visible region.

5. The method according to claim 1, wherein the obstacle avoidance strategy comprises:
based on the visible region being smaller than a size of the display screen, using a split-screen display mode to display the image content completely in a screen of a standby display device, or using an obstacle avoidance mode for adjusting a content layout to display the image content completely in the real visible region.

6. The method according to claim 1, wherein the obstacle avoidance strategy comprises:
based on the visible region being smaller than the size of the display screen, and there being a respective standby display device for the viewer, using the split-screen display obstacle avoidance mode to display the image content completely in the screen of the standby display device; and
based on the visible region not being smaller than the size of the display screen, using the obstacle avoidance mode for adjusting a content layout to display the image content completely in the visible region.

7. The method according to claim 5, wherein the obstacle avoidance mode for adjusting a content layout comprises:
displaying primitives of the image content completely in the visible region by adjusting a layout of the primitives in the image content, the primitives being smallest indivisible display elements in the image content.

8. The method according to claim 7, wherein the obstacle avoidance mode for adjusting a content layout comprises:
identifying a type of the image content, wherein the type comprises a plain text, a plain picture, a combination of a text and a picture, and a special type, wherein the special type is image content containing special primitives, and elements of the special primitives have interrelated structural relationships with each other;
acquiring display attribute information of each primitive in the image content according to an identified type, the display attribute information comprising: size and position coordinate information of the each primitive in the picture and information of spacing with a neighboring primitive and an arrangement direction;
searching, as an occluded primitive, a primitive which is not completely covered by the real visible region based on the display attribute information of the primitives; and
adjusting the layout of the primitives in the image content based on the type of the image content, the display attribute information of the primitives, and a type of the occluded primitive, according to a preset rearrangement strategy, to display the occluded primitive completely in the visible region.

9. The method according to claim 8, wherein the acquiring display attribute information of each primitive in the image content comprises:
extracting each primitive in the image content according to the type of the image content to obtain size and position coordinate information of each primitive in the image content in the picture; and
obtaining information of spacing with a neighboring primitive and an arrangement direction of a respective primitive in the picture based on the size and position coordinate information of the each primitive in the picture.

10. The method according to claim 8, wherein the rearrangement strategy comprises:
based on the type of the image content being the plain picture, determining a maximum region occupied by the occluded primitive in the real visible region, and after reducing the occluded primitive to be completely displayed in the maximum region based on the display attribute information of the primitives, moving a position of the occluded primitive to display the occluded primitive completely in the maximum region;
based on the type of the image content being the plain text or the special type, taking the real visible region as a screen region for displaying the image content, and based on the display attribute information of the primitives, performing a respective re-typesetting on the primitives in the image content to display the primitives completely in the real visible region; and
based on the type of the image content being the combination of the text and the picture,
based on the occluded primitive being a picture primitive, removing a region occupied by the text in the image content from the real visible region to obtain a first sub-region, calculating a maximum region which is able to be occupied by the occluded primitive in the first sub-region, and based on the display attribute information of the primitives, after reducing the occluded primitive to be completely displayed in the maximum region, moving a position of the occluded primitive to display the occluded primitive completely in the maximum region;
based on the occluded primitive not being a picture primitive, calculating a first area which needs to be occupied when text content in the image content is displayed in the real visible region; based on the first area, determining a maximum region which is able to be occupied when picture content of the image content is displayed in the real visible region, and based on the display attribute information of the picture primitive, after reducing the picture primitive in the image content to be completely displayed in the maximum region, moving a position of the picture primitive to display the picture primitive completely in the maximum region; taking a remaining region in the real visible region after removing the maximum region as a display region of a text primitive in the image content, and based on the display attribute information of the text primitive, performing a respective re-typesetting on the text primitive in the image content to display each text primitive in the remaining region, an area of the remaining region being not less than the first area.

11. An obstacle avoidance playing apparatus comprising:
data collection circuitry, configured to acquire human eye position information of a viewer in a playing scene and three-dimensional data of an object in a respective viewing space region;
visible region generation circuitry, configured to determine a visible region of a display screen, based on the human eye position information, the three-dimensional data of the object, and size and position information of the display screen, the visible region corresponding to a portion of the display screen that is unobstructed to the viewer; and
obstacle avoidance processing circuitry, configured to display image content using (i) a matched obstacle avoidance mode being determined based on the visible region and (ii) a preset obstacle avoidance strategy such that the image content is displayed in the visible region.

12. The obstacle avoidance playing electronic device according to claim 1, comprising a processor and a memory;
the memory storing an application program executable by the processor, configured to cause the processor to perform the obstacle avoidance playing method.

13. A non-transitory computer-readable storage medium having instructions stored therein, which when executed by a processor cause the processor to execute an obstacle avoidance playing method comprising:
acquiring human eye position information of a viewer in a playing scene and three-dimensional data of an object in a respective viewing space region;
determining a visible region of a display screen based on the human eye position information, the three-dimensional data of the object, and size and position information of the display screen, the visible region corresponding to a portion of the display screen that is unobstructed to the viewer; and
displaying image content using (i) a matched obstacle avoidance mode determined based on the visible region and (ii) a preset obstacle avoidance strategy such that the image content is displayed in the visible region.

14. The non-transitory computer readable medium according to claim 13, wherein the determining the visible region of the display screen comprises:
establishing a three-dimensional map of the playing scene based on the human eye position information, the three-dimensional data, and the size and position information of the display screen;
determining, for each viewer, a corresponding occlusion region in the display screen of each obstacle within a viewing range of the viewer based on the three-dimensional map; and
generating the visible region of the display screen based on each occlusion region.

15. The non-transitory computer readable medium according to claim 14, wherein the determining the corresponding occlusion region in the display screen of each obstacle within the viewing range of the viewer based on the three-dimensional map comprises:
obtaining a visible cone range of the viewer based on the human eye position of the viewer in the three-dimensional map and the size and position information of the display screen; and
determining, as the occlusion region for each of the objects, whether the object has a point in the visible cone range based on reconstruction data of the object in the three-dimensional map, and based on the determination that the object has the point in the visible cone range, calculating a display region which is not viewable by the viewer due to occlusion of the object.

16. The non-transitory computer readable medium according to claim 15, wherein the generating the visible region of the display screen comprises:
removing each occlusion region from a complete display region of the display screen to obtain the visible region.

17. The non-transitory computer readable medium according to claim 14, wherein the obstacle avoidance strategy comprises:
based on the visible region being smaller than a size of the display screen, using a split-screen display mode to display the image content completely in a screen of a standby display device, or using an obstacle avoidance mode for adjusting a content layout to display the image content completely in the real visible region.

18. The non-transitory computer readable medium according to claim 14, wherein the obstacle avoidance strategy comprises:
based on the visible region being smaller than the size of the display screen and there being a respective standby display device for the viewer, using the split-screen display obstacle avoidance mode to display the image content completely in the screen of the standby display device; and
based on the visible region not being smaller than the size of the display screen, using the obstacle avoidance mode for adjusting a content layout to display the image content completely in the visible region.

19. The non-transitory computer readable medium method according to claim 17, wherein the obstacle avoidance mode for adjusting a content layout comprises:
displaying primitives of the image content completely in the visible region by adjusting a layout of the primitives in the image content, the primitives being smallest indivisible display elements in the image content.

20. The non-transitory computer readable medium according to claim 19, wherein the obstacle avoidance mode for adjusting a content layout comprises:
identifying a type of the image content, wherein the type comprises a plain text, a plain picture, a combination of a text and a picture, and a special type, wherein the special type is image content containing special primitives, wherein elements of the special primitives have interrelated structural relationships with each other;
acquiring display attribute information of each primitive in the image content according to an identified type, the display attribute information comprising: size and position coordinate information of the each primitive in the picture and information of spacing with a neighboring primitive and an arrangement direction;
searching, as an occluded primitive, a primitive which is not completely covered by the real visible region based on the display attribute information of the primitives; and
adjusting the layout of the primitives in the image content based on the type of the image content, the display attribute information of the primitives, and a type of the occluded primitive, according to a preset rearrangement strategy, to display the occluded primitive completely in the visible region.
